(19) United States
(12) Patent Application Publication
(10) Pub. No.: US 2005/0149565 A1
(43) Pub. Date: Jul. 7, 2005

(54) Printing apparatus and method of providing a contents list and automatically printing selected content

(76) Inventors: Seung-soo Oak, Seongnam-si (KR); Jae-kyung Cho, Suwon-si (KR)

Correspondence Address: STANZIONE & KIM, LLP, 1740 N STREET, N.W., FIRST FLOOR, WASHINGTON, DC, 20036, US

(21) Appl. No.: 10/953,371

(22) Filed: Sep. 30, 2004

(30) Foreign Application Priority Data
Dec. 27, 2003 (KR) 2003-98029

(51) Int. Cl. G06F 7/00

(52) U.S. Cl. 707/104.1

(57) ABSTRACT

A printing apparatus and method of providing a contents list and automatically printing selected contents. The printing apparatus includes a print part to print contents, and a control part to provide to a client a contents list, and to receive at least one content from a contents-providing server if the client selects the at least one content by referring to the contents list, and to supply the content to the print part. Thus, users do not have to look into and input URLs at which information regarding the at least one content is located. Further, the contents list contains words referring to what information the contents contain, so the users can obtain the information of the contents and more easily select the information which the user wants to print. Furthermore, despite changes of the URLs for the contents, the users do not have to input the changes since the URLs can be automatically updated.

### CROSS-REFERENCE TO RELATED APPLICATIONS

This application claims benefit under 35 U.S.C. 119 from Korean Patent Application No. 2003-98029, filed on Dec. 27, 2003, the entire content of which is incorporated herein by reference.

### BACKGROUND OF THE INVENTION

1. Field of the Invention

The present general inventive concept relates to a printing apparatus and method, and more particularly, to a printing apparatus and method of downloading and printing contents referring to useful information.

2. Description of the Related Art

In general, printers are the most common means outputting computer-processed information as visible materials. In recent years, a method of enhancing a work efficiency has been used in a printer connected to a network and shared by plural users.

Furthermore, a printing system has emerged to be connected to the Internet, to be hooked up to websites providing useful information, such as news, stock, sports, weather, and so on, and to automatically print web documents containing such information.

FIG. 1 is a block diagram showing a conventional printing system for automatically printing web documents. In FIG. 1, the printing system shows that a user PC 10, a printer 30, and a contents-providing server 50 are connected to one another through a network. The user PC 10 and the printer 30 are connected to each other through a Local Area Network (LAN) 20, and the printer 30 and the contents-providing server 50 are connected to each other through the Internet 40.

The contents-providing server 50 provides useful information, such as news, stock, sports, weather, and so on, and generally updates the useful information in real time. Furthermore, a uniform resource locator (URL) at which the useful information is located can be changed as well.

The printer 30 is equipped with a network connector, such as a network printer card, to be connected to the contents-providing server 50 every printing period set by a user, and receives and prints the web documents containing the useful information. Here, the printer 30 uses information of the URL at which the useful information is located in order to connect the network connector to the contents-providing server 50.

A user sets the printing period and data to be printed through the user PC 10. At this time, the user has to directly input the information of the URL about the data the user wants to print.

In this conventional printing system, the user has to search for URLs at which the useful information is located, and also has to input the URLs in the user PC 10 or the printer 30, in order to print the useful information. Further, the user has to select information he or she wants to print by referring to an URL list, but the URL list consists of only URLs rather than contents of the useful information. Therefore, it is difficult for the user to obtain information on the contents which the URLs contain. This causes the user inconvenience in selecting the useful information.

Furthermore, the URLs at which the useful information is located can be changed from time to time, and the user has to input the changed URLs every time the URLs have been changed, which can bother the user.

### SUMMARY OF THE INVENTION

In order to solve the above and/or other problems, it is an aspect of the present general inventive concept to provide a printing apparatus and method of providing a user with a contents list, such as a list of contents referring to useful information, connecting a printer to corresponding contents-providing servers using URL information of the contents selected by the user, and downloading and printing corresponding contents.

Additional aspects and advantages of the present general inventive concept will be set forth in part in the description which follows and, in part, will be obvious from the description, or may be learned by practice of the general inventive concept.

The foregoing and/or other aspects of the present general inventive concept may be achieved by providing a printing apparatus including a print part to print contents, and a control part to provide to a client a contents list being a list, such as of contents, if the client selects a certain content by referring to the contents list, to receive the content from a contents-providing server providing the selected content, and to supply the content to the print part.

In an aspect of the present general inventive concept, the contents list can contain words referring to what information the contents contain.

In another aspect of the present general inventive concept, the control part can receive the contents list from a contents search server to update the contents list in real time and can store the received contents list, and can provide the client with the received contents list.

In another aspect of the present general inventive concept, the control part can receive uniform resource locator (URL) information corresponding to contents selected by the client from a contents search server storing the URL information of the contents, and connects the printing apparatus to the contents-providing server using the received URL information, to receive the contents.

In another aspect of the present general inventive concept, the URL information of the contents can be updated in real time.

In another aspect of the present general inventive concept, if a pre-set period of time lapses, the control part can receive from the contents search server the URL information of the contents selected by a client.

In another aspect of the present general inventive concept, the printing apparatus may further include a storage part to store a list of the contents selected by the client, and the control part can receive from the contents search server the URL information of the contents included in the list of the selected contents stored in the storage part.

The foregoing and/or other aspects of the present general inventive concept may also be achieved by providing a printing method including providing to a client a contents list as a list of contents, selecting a certain content by the client by referring to the contents list, receiving the content from a contents-providing server providing the selected content by the client, and printing the received content.

In an aspect of the present general inventive concept, the contents list can contain words referring to what information the contents contain.

In another aspect of the present general inventive concept, the providing of the content list can include receiving the contents list from the contents search server to update the content list in real time and to store the received contents list, and providing the client with the received contents list.

In another aspect of the present general inventive concept, the receiving of the content can include receiving URL information of contents selected by the client from a contents search server to store the URL information of the contents, and connecting a printer to the contents-providing server using the received URL information, and receiving the contents.

In another aspect of the present general inventive concept, the URL information of the contents can be updated in real time.

In another aspect of the present general inventive concept, the receiving of the URL information can be carried out if a pre-set period of time lapses.

In another aspect of the present general inventive concept, the receiving of the content can include storing a list of the contents selected by the client, and receiving from the contents search server the URL information of the contents included in the list of the selected contents stored.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a block diagram showing a conventional printing system automatically printing web documents;

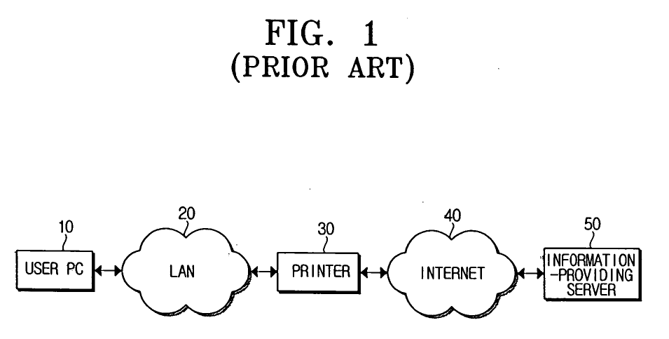

FIG. 2 is a block diagram showing a printing system to provide a contents list and to automatically print selected contents according to an embodiment of the present general inventive concept;

FIG. 3 is a view showing a message sequence chart provided to explain the printing system of FIG. 2;

FIG. 4 is a block diagram showing a printer of FIG. 2; and

FIG. 5 is a flow chart showing a process of providing a contents list and automatically printing selected contents according to another embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

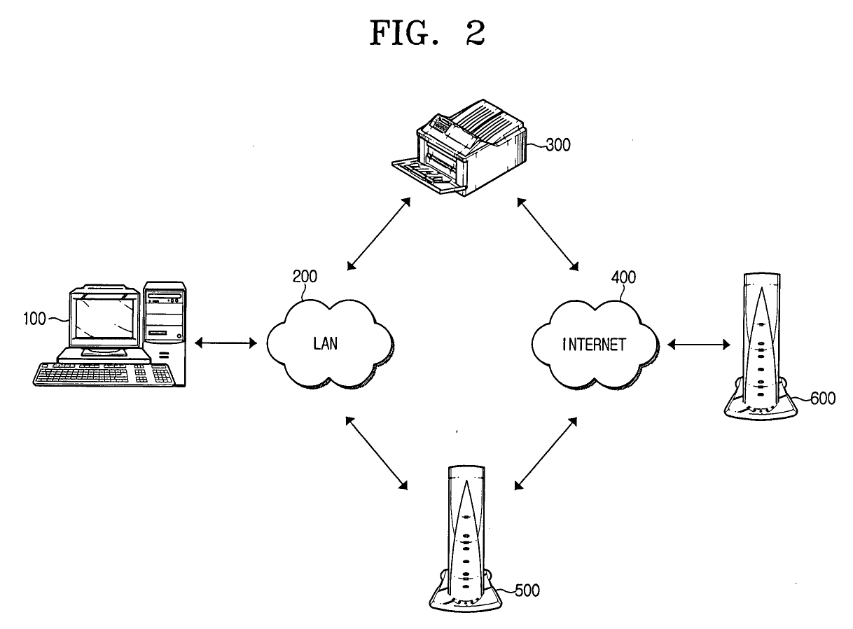

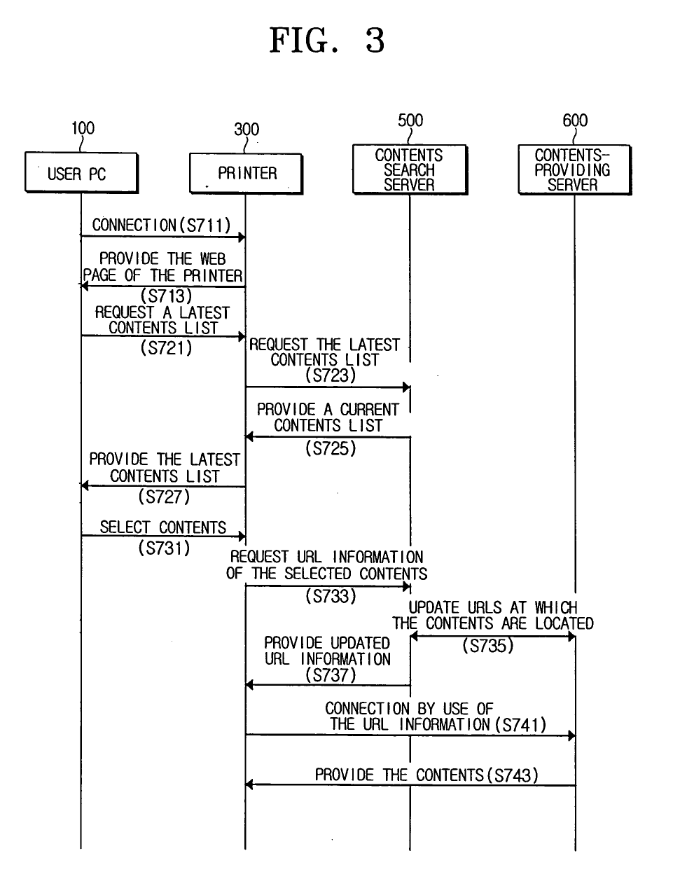

FIG. 2 is a block diagram showing a printing system to provide a contents list automatically print selected contents according to an embodiment of the present general inventive concept, and FIG. 3 is a view showing a message sequence chart provided to explain the printing system of FIG. 2.

Referring to FIGS. 2 and 3, the printing system can include a user PC 100, a printer 300, a contents search server 500, and a contents-providing server 600 that are connected to one another through a communication network. The user PC 100, the printer 300, and the contents search server 500 are connected to one another through a local area network (LAN) 200, and the printer 300, the contents search server 500, and the contents-providing server 600 are connected to one another through the internet 400.

The hypertext transfer protocol (HTTP) can be applied to communications between the user PC 100 and printer 300, communications between the printer 300 and the contents search server 500, and communications between the contents search server 500 and contents-providing server 600, and communications between the printer 300 and the contents-providing server 600. The HTTP is a protocol used to receive and transmit data, such as text, graphic images, sound, or audio, between HTTP servers and HTTP clients.

The user PC 100 can request a communication connection to the printer 300 through a built-in browser (S711). That is, the user PC 100 runs the built-in browser to input an IP address corresponding to the printer 300. Here, the user PC 100 acts as an HTTP client requesting communications with the printer 300.

A user can request an updated contents list, i.e., a list of contents, a table of contents, or a list (table) of topics, using a web page which the printer 300 supplies to the user PC 100 (S721). Further, the user can select contents using a page showing the contents list that is displayed as the web page (S731). Furthermore, the user can establish a print period of time to print the contents on the web page.

Here, the contents (topics) refer to information useful to the user, such as news, stock, sports, weather, and so on. The contents can be provided on a web page of the contents-providing server 600 and can be updated in real time. The contents list can include, as a list of contents, a list of words referring to what information the contents contain. The print period of time refers to a period for downloading and printing the contents as the printer 300 is connected to the contents-providing server 600. The user can set a connection period of time to every hour, day, or week, and can change the connection period of time if needed.

Although the printer 300 can be a network printer connected to at least one or more user PCs 100 through the LAN 200, only one printer 300 is shown to be connected to one user PC 100 for the sake of explanation in this embodiment.

The printer 300 can provide the user PC 100 with the web page of the printer 300 that is created in the hypertext markup language (HTML) in response to the communication connection request of the user PC 100 (S713). Thus, the printer 300 acts as an HTTP server to provide information requested by the user PC 100. The user can obtain information of a specification of the printer 300 through the web page of the printer 300 to configure the environment of the printer 300 or to select and use functions which the printer 300 supports. The printer 300 can be connected to the contents search server 500 through the LAN 200 or the Internet 400.

If the printer 300 is requested to print a latest contents list by the user PC 100, the printer 300 requests the latest contests list to the contents search server 500 (S723). Here, the printer 300 acts as an HTTP client to request communications with the contents search server 500. Further, the printer 300 can provide the user PC 100 with the latest contents list supplied by the contents search server 500 (S727).

Further, the printer 300 can store a new list of contents selected by a user. If the print period of time set by the user lapses, the printer 300 can request the contents search server 500 to provide URL information of the contents selected by the user (S733).

The printer 300 can be connected to the corresponding contents-providing server 600 using the URL information of the contents provided by the contents search server 500, and can request the corresponding contents (S741). Here, the printer 300 can act as an HTTP client to request communications with the contents-providing server 600. Further, the printer 300 can download and print the corresponding contents from the contents-providing server 600.

The contents search server 500 can be a server that not only stores the contents list and the URLs at which the contents are located, but also provides the URLs to the printer 300. Plural printers can be connected to the contents search server 500, but only one printer 300 is shown to be connected to the contents search server 500 for the sake of explanation in this embodiment.

The contents search server 500 can store in a database format the contents list, the URL information of respective contents, information on connectable printers, and the URL information of the contents to be supplied to individual printers, and can have a built-in search engine to search for and update URLs at which the contents are located in real time.

The contents search server 500 can drive the built-in search engine, can obtain the URL information at which the contents are located, and can update and store the URL information of the contents from time to time (S735).

Further, if the contents search server 500 is requested by the printer 300 to supply the latest contents list, the contents search server 500 can provide the currently stored contents list to the printer 300 (S725). Here, the contents search server 500 can serve as an HTTP server to provide information requested by the printer 300.

If the contents search server 500 is requested by the printer 300 to supply the URL information of the contents, the contents search server 500 can compare the URL information previously provided to the printer 300 and the currently stored URL information, and can send updated URL information to the printer 300 (S737).

The contents-providing server 600 can be a server to provide the contents. In general, plural contents-providing servers can work depending upon the kinds of contents, but only one contents-providing server 600 is shown for the sake of explanation in this embodiment.

If the contents-providing server 600 is requested by the printer 300 to supply the contents, the contents-providing server 600 can provide the contents created in HTML to the printer 300 (S743). Here, the contents-providing server 600 can serve as an HTTP server to provide information requested by the printer 300.

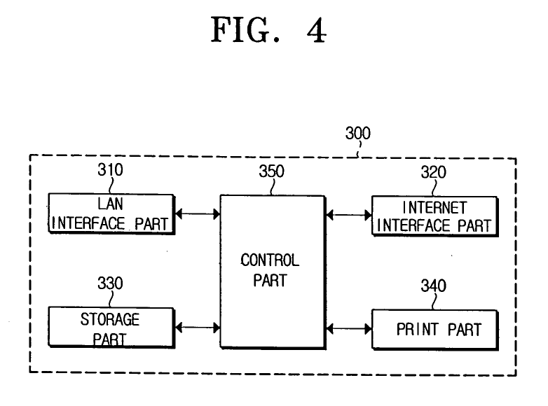

FIG. 4 is a block diagram showing the printer 300 of FIG. 2. In FIG. 4, the printer 300 can have a LAN interface part 310, an Internet interface part 320, a storage part 330, a print part 340, and a control part 350.

Referring to FIGS. 2 through 4, the LAN interface part 310 can be connected to the user PC 100 or the contents search server 500 through the LAN 200 to provide a communication interface to communicate with the user PC 100 or the contents search server 500.

The Internet interface part 320 can be connected to the contents-providing server 600 through the internet 400 to provide a communication interface to communicate with the contents-providing server 600.

The storage part 330 can store the contents list and the URL information of respective contents that are provided by the contents search server 500, the list of contents selected by the user, and the web page of the printer 300. Further, the storage part 330 can be installed with drivers to drive the printer 300 and other application programs, in addition to browsers to connect the contents-providing server 600 and a printer emulator serving as an HTML interpreter enabling to print the contents created in HTML and provided from the contents-providing server 600.

The print part 340 can carry out with a printing operation of printing data according to a control of the control part 350.

If the control part 350 receives the communication connection request of the user PC 100 through the LAN interface part 310, the control part 350 can provide the user PC 100 with the web page of the printer 300 stored in the storage part 330. Further, if the control part 350 is requested to provide the latest contents list by the user PC 100 through the LAN interface part 310, the control part 350 can request the latest contents list to the contents search server 500 and can supply to the user PC 100 the latest contents list provided by the contents search server 500.

Further, the control part 350 can store in the storage part 330 the list of contents selected by the user. Furthermore, the control part 350 can have a timer that can check whether or not the print period of time set by a user lapses.

If the print period of time set by a user lapses, the control part 350 can request the contents search server 500 through the LAN interface part 310 to send the URL information of the contents selected by the user, and can be connected to the corresponding contents-providing server 600 through the internet interface part 320 using the URL information provided by the contents search server 500, and can request the corresponding contents.

Further, the control part 350 can convert the corresponding contents provided by the contents-providing server 600 through the internet interface part 320 into data suitable for printing (or referred to as print data), and can finish the print data to the print part 340 to print the print data.

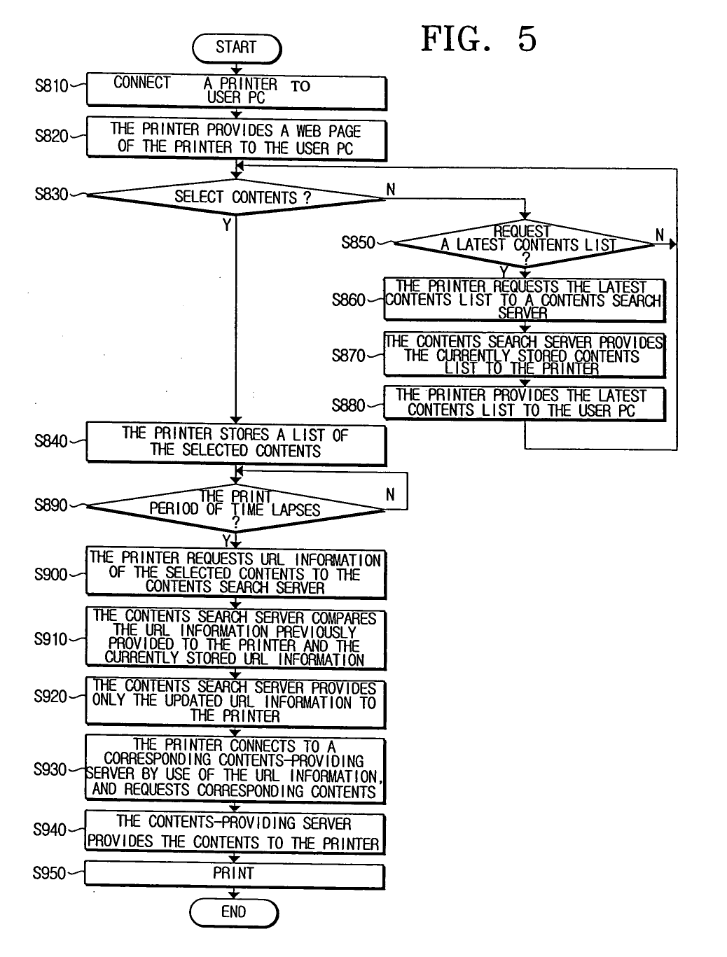

Hereinafter, description will be made on a process of the printer 300 to print the contents selected by the user with reference to FIG. 5. FIG. 5 is a flow chart showing a process of providing a contents list and automatically printing selected contents according to another embodiment of the present invention.

Referring to FIGS. 2 through 5, if the user connects the printer 300 to the user PC 100 (S810), the printer 300 can provide the user PC 100 with the web page of the printer 300 created in HTML in response to the communication connection request of the user PC 100 (S820).

The web page of the printer 300 can show a list of printable contents topics, such as news, stock, sports, weather, and so on, together with a ‘latest contents list’ option provided for requests of the latest contents list, a ‘contents selection’ option provided for selections of the contents to be printed out of the shown contents list, a ‘print period of time setting’ option provided for settings of print periods of time of the contents, and the like. The user can select options on the web page of the printer 300.

If the user selects the ‘contents selection’ option and then selects the contents the user wants to print with reference to the contents list shown on the web page (S830), the printer 300 can store in the storage part 330 the list of contents selected by the user (S840).

On the other hand, if the user selects the ‘latest contents’ option and requests the latest contents list (S850), the printer 300 may request the latest contents list to the contents search server 500 in response to the request of the user PC 100 (S860), and the contents search server 500 can provide a currently stored contents list to the printer 300 in response to the request of the printer 300 (S870). Further, the printer 300 can provide to the user PC 100 the contents list provided from the contents search server 500 (S880). Thus, the latest contents list is shown on the web page of the printer 300, so the user can carry out operation S830 by referring to the contents list.

Next, the control part 350 of the printer 300 can decide whether the print period of time set by the user lapses (S890).

If it is decided in operation S890 that the print period of time lapses, the printer 300 can read out the list of contents selected by the user that has been stored in the storage part 350, and requests the URL information of the read contents to the contents search server 500 (S900).

The contents search server 500 can refer to its own database, and can compare the URL information of contents previously provided and the URL information of contents currently stored (S910).

Further, based on a result of the comparison operation S910, the contents search server 500 can provide to the printer 300 the URL information updated with respect to the contents according to a difference between the two compared URL information (S920).

Since the URL information of the contents can be changed from time to time, the contents search server 500 can update the URL information of the contents in real time. Further, if the contents search server 500 is requested by the printer 300 to send the URL information of the contents selected by a user, the contents search server 500 can compare the URL information provided to the printer 300 and the currently updated URL information to provide the URL information which is different from the previous URL information as a result of the comparison, that is, only the updated URL information is provided to the printer 300, so data communications can be maximized in efficiency.

The printer 300 can update URL information of the contents stored in the storage part 330 according to the URL information provided from the contents search server 500. Further, the printer 300 can be connected to the contents-providing server 600 using the URL information of the contents stored in the storage part 330, and can request the corresponding contents (S930).

Next, if the printer 300 is provided from the contents-providing server 600 with the requested contents (S940), the print part 340 of the printer 300 can carry out with the printing operation to print the provided contents (S950).

Thus, when the user selects the contents rather than URLs, the printer 300 can obtain the URL information of the selected contents and to automatically print the contents according to the print period of time that has been set.

As described above, the present general inventive concept provides a user with a list of contents, i.e., useful information. If the user selects contents to be printed, the printer can be connected to corresponding contents-providing servers using the URL information of the selected contents, and download and print corresponding contents. Thus, the user does not have to look into one by one and input URLs at which the information is located, in order to print the information. Further, since the contents list includes words referring to what the contents contain, the user can obtain what the respective contents contain, so as to more easily select desired information. Further, despite the changes of the URLs for the contents, the present general inventive concept does not require the user to input the changes, which enhances convenience.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A printing apparatus, comprising:
a print part to print contents; and
a control part to provide to a client a contents list, to receive at least one content from an external contents-providing server when the at least one content is selected from the contents list, and to supply the received content to the print part.

2. The printing apparatus as claimed in claim 1, wherein the contents list contains words corresponding to information contained in the contents.

3. The printing apparatus as claimed in claim 2, wherein the control part receives a new contents list from an external contents search server to update the contents list with the new contents list in real time and to store the new contents list, and provides the client with the received new contents list.

4. The printing apparatus as claimed in claim 2, wherein the control part receives uniform resource locator (URL) information of contents selected by the client from the contents search server storing the URL information of the contents, and connects the print part to the contents-providing server using the received URL information, and receives the contents.

5. The printing apparatus as claimed in claim 4, wherein the URL information of the contents is updated in real time.

6. The printing apparatus as claimed in claim 4, wherein the control part receives from the contents search server the URL information of the contents selected by the client if a preset period of time lapses.

7. The printing apparatus as claimed in claim 6, further comprising:
a storage part to store the list of the contents selected by the client,
wherein the control part receives from the contents search server the URL information of the contents included in the list of the selected contents stored in the storage part.

8. A printing method comprising:
providing to a client a contents list corresponding to a plurality of contents;
selecting a certain content by the client by referring to the contents list;
receiving the selected content from an external contents-providing server; and
printing the received content.

9. The printing method as claimed in claim 8, wherein the contents list contains words corresponding to information contained in the contents.

10. The printing method as claimed in claim 9, wherein the providing of the contents list comprises:
receiving the contents list from an external contents search server updating in real time and storing the contents list; and
providing the client with the received contents list.

11. The printing method as claimed in claim 9, wherein the receiving of the contents comprises:
receiving URL information of contents selected by the client from an external contents search server storing the URL information of the contents; and
connecting a print part to the contents-providing server using the received URL information, and receiving the content.

12. The printing method as claimed in claim 11, wherein the receiving of the URL information of the contents comprises updating the URL information with new URL information of the contents in real time.

13. The printing method as claimed in claim 11, wherein the receiving of the URL information comprises receiving the URL information if a pre-set period of time lapses.

14. The printing method as claimed in claim 13, wherein the receiving of the content comprises:
storing a list of the contents selected by the client; and
receiving from the contents search server the URL information of the contents included in the list of the selected contents stored.

15. A printing apparatus, comprising:
a storage part to store a list of contents and URL information corresponding to the respective contents; and
a control part to receive new URL information corresponding to the respective contents, and to control the storage part to update the URL information with the received new URL information.

16. The printing apparatus as claimed in claim 15, wherein the control part receives a new list of new contents, and the received new URL information corresponds to respective new contents.

17. The printing apparatus as claimed in claim 15, wherein the control part receives a new list of new contents and receives the newly updated URL information when there is a difference between the new URL information and the URL information with respect to the new contents.

18. The printing apparatus as claimed in claim 15, wherein the control part receives a new list of new contents, and the new URL information represents a difference between the contents and the new contents.

19. The printing apparatus as claimed in claim 18, wherein the new contents are selected from the list of the contents stored in the storage part, and the updated URL information comprises first information in which the URL information is the same as the new URL information, and second information in which the URL information is different from the new URL information.

20. The printing apparatus as claimed in claim 15, wherein the control part is connectable to a computer apparatus to display a web page containing the list of the contents, and the new contents are selected from the list of the contents through the web page to form the new list of the new contents.

21. The printing apparatus as claimed in claim 20, wherein the web page further comprises a latest contents list option to receive a latest contents list, and a contents selection option to receive and print at least one of the contents.

22. The printing apparatus as claimed in claim 21, wherein the control part receives the latest contents list having latest contents selected from the list of the contents as the new list of the new contents when the latest contents list option is selected from the web page.

23. The printing apparatus as claimed in claim 21, wherein the control part receives the new URL information corresponding to the respective latest contents.

24. The printing apparatus as claimed in claim 21, wherein the control part receives the new list of the new contents as the latest contents list when the latest contents list option is selected from the web page, and the control part receives the new URL information corresponding to the respective latest contents.

25. The printing apparatus as claimed in claim 21, wherein the latest contents list is displayed in the web page.

26. The printing apparatus as claimed in claim 21, wherein the control part controls the storage part to store the latest contents list and the new URL information.

27. The printing apparatus as claimed in claim 20, wherein the web page further comprises a print period setting option to set a print period of time, and the control part automatically receives the newly updated URL information of the respective contents according to the print period of time.

28. The printing apparatus as claimed in claim 27, wherein the control part receives the new contents according to the newly updated URL information and automatically prints the received contents.

29. The printing apparatus as claimed in claim 20, further comprising:
a print part to print the contents,
wherein the web page further comprises a characteristic of the print part, and the characteristic of the print part can be adjusted through the web page.

30. The printing apparatus as claimed in claim 15, wherein the control part is connectable to a contents search server through a local area network or the Internet to receive the new list of the new contents and the new URL information.

31. The printing apparatus as claimed in claim 30, wherein the contents search server is connectable to a contents-providing server to receive the new list of the new contents and transmits the received new list of the new contents to the control part.

32. The printing apparatus as claimed in claim 15, wherein the control part is connectable to a contents-providing server using the received new URL information to receive corresponding ones of the contents.

33. A printing system, comprising:
a printing apparatus having a storage part to store a list of contents and URL information corresponding to the respective contents, and a control part to generate a web page, to receive newly updated URL information corresponding to the respective contents, and to control the storage part to update the URL information with the received new URL information;
a computer apparatus to display the web page containing the list of the contents, and to select the new contents from the list of the contents through the web page to form the new list of the new contents; and
a contents search server to output at least one of the new list of the new contents and the new URL information to the printing apparatus.

34. A printing system, comprising:
a printing apparatus having a storage part to store a list of contents and URL information corresponding to the respective contents, and a control part to generate a web page, to receive newly updated URL information corresponding to the respective contents, and to control the storage part to update the URL information with the received new URL information;
a contents-providing server to output a current list of contents in response to the stored list of contents to the printing apparatus, and to output the new URL information in response to a new list of contents selected from the current list of contents to the printing apparatus; and
a computer apparatus to display the web page including at least one of the new list of the new contents and the current list of contents.

35. A method of a printing apparatus, the method comprising:
storing a list of contents and URL information corresponding to the respective contents;
receiving newly updated URL information corresponding to the respective contents; and
updating the URL information with the received new URL information.

36. The method as claimed in claim 35, further comprising:
receiving a new list of new contents,
wherein the receiving of the newly updated URL information comprises receiving the new URL information corresponds to respective new contents.
